(19) United States
(12) Patent Application Publication
(10) Pub. No.: US 2025/0028560 A1
(43) Pub. Date: Jan. 23, 2025

(54) AUTOMATED SCHEDULING OF SOFTWARE DEFINED DATA CENTER (SDDC) UPGRADES AT SCALE THROUGH OPTIMIZED GRAPHICAL USER INTERFACE

(71) Applicant: VMware LLC, Palo Alto, CA (US)

(72) Inventors: Marc UMENO, Sunnyvale, CA (US); Deepa RAO, Austin, TX (US); Vijayakumar KAMABATHULA, Leander, TX (US); Hsuan YANG, San Mateo, CA (US); Ruman HASSAN, Palo Alto, CA (US); Vaibhav KOHLI, Austin, TX (US)

(21) Appl. No.: 18/355,215

(22) Filed: Jul. 19, 2023

(51) Int. Cl. G06F 9/50; G06F 3/04847

(52) U.S. Cl. CPC G06F 9/5027; G06F 3/04847

(57) ABSTRACT

The disclosure provides an approach for automatically scheduling resource-aware software-defined data center (SDDC) upgrades. Embodiments include receiving, via a user interface (UI), user input indicating one or more constraints related to automatically scheduling a plurality of upgrade phases for upgrading components of a plurality of computing devices across a plurality of SDDCs. Embodiments include receiving, via the UI, a user selection of a first UI control that, when selected, initiates an automatic assignment of the plurality of upgrade phases to particular time slots based on the one or more constraints. Embodiments include displaying, via the UI, a depiction of a schedule for the plurality of upgrade phases based on the automatic assignment. Embodiments include displaying, via the UI, a second UI control that, when selected, causes the automatic assignment to be finalized and a third UI control that, when selected, initiates a new automatic assignment.

### BACKGROUND

A software-defined data center (SDDC) generally comprises a plurality of hosts in communication over a physical network infrastructure. For example, SDDCs may be provided via software as a service (SaaS) to a plurality of customers. Each host of an SDDC is a physical computer (machine) that may run one or more virtualized endpoints such as virtual machines (VMs), containers, and/or other virtual computing instances (VCIs). In some cases, VCIs are connected to software-defined networks (SDNs), sometimes referred to as logical overlay networks, that may span multiple hosts and are decoupled from the underlying physical network infrastructure.

Services related to SDDCs, such as virtual network infrastructure software, may need to undergo maintenance on occasion, such as being upgraded, patched, or otherwise modified. In some cases, such a maintenance action is referred to as a rollout. Providing rollouts to services that are running on multiple data centers (e.g., providing a service upgrade to a potentially large number of customers that utilize a given service on their data centers) is challenging for a variety of reasons. For example, a rollout schedule for SDDCs provided via SaaS to a plurality of customers may need to be generated based on various constraints such as customer maintenance preferences (e.g., date and time preferences expressed by customers), SDDC regional preferences (e.g., date and time preferences applicable to the region in which an SDDC is located), the availability of support resources such as support professionals to assist with activities related to the rollout, and/or the like. Preparing such a schedule is a complicated, tedious, time-consuming, and error-prone process, particularly for a rollout that involves a large number of SDDCs. Furthermore, even if all parties' preferences are taken into account, rollout activities may still interfere with normal operations on the SDDCs, such as if rollout activities utilize physical computing resources that are needed by other processes on the SDDCs at a particular time, if rollout activities fail and cause disruptions to workflows on an SDDC, if rollouts cause services to be unavailable at inopportune times, and/or the like. Additionally, configuration and management of such rollout activities may be difficult for a variety of reasons, such as due to the potentially large number of components involved and the challenges associated with obtaining information about such disparate components, determining the effects of a particular rollout plan on such components, and implementing such a rollout plan on such disparate components.

Accordingly, there is a need in the art for improved techniques for configuration and management of maintenance operations across multiple SDDCs, particularly in cases where maintenance operations need to be performed across a large number of SDDCs (e.g., thousands).

### BRIEF DESCRIPTION OF THE DRAWINGS

FIG. 1 depicts example physical and virtual network components with which embodiments of the present disclosure may be implemented.

FIG. 2 illustrates an example related to automated resource-aware scheduling of software-defined data center (SDDC) upgrades.

FIG. 3 illustrates an example user interface screen related to configuration and management of automated resource-aware scheduling of SDDC upgrades.

FIG. 4 illustrates another example user interface screen related to configuration and management of automated resource-aware scheduling of SDDC upgrades.

FIG. 5 illustrates another example user interface screen related to configuration and management of automated resource-aware scheduling of SDDC upgrades.

FIG. 6 illustrates another example user interface screen related to configuration and management of automated resource-aware scheduling of SDDC upgrades.

FIG. 7 illustrates another example user interface screen related to configuration and management of automated resource-aware scheduling of SDDC upgrades.

FIG. 8 illustrates another example user interface screen related to configuration and management of automated resource-aware scheduling of SDDC upgrades.

FIG. 9 illustrates another example user interface screen related to configuration and management of automated resource-aware scheduling of SDDC upgrades.

FIG. 10 illustrates another example user interface screen related to configuration and management of automated resource-aware scheduling of SDDC upgrades.

FIG. 11 illustrates another example user interface screen related to configuration and management of automated resource-aware scheduling of SDDC upgrades.

FIG. 12 illustrates another example user interface screen related to configuration and management of automated resource-aware scheduling of SDDC upgrades.

FIG. 13 illustrates another example user interface screen related to configuration and management of automated resource-aware scheduling of SDDC upgrades.

FIG. 14 illustrates another example user interface screen related to configuration and management of automated resource-aware scheduling of SDDC upgrades.

FIG. 15 illustrates another example user interface screen related to configuration and management of automated resource-aware scheduling of SDDC upgrades. FIG. 16 illustrates another example user interface screen related to configuration and management of automated resource-aware scheduling of SDDC upgrades.

FIG. 17 depicts example operations related to configuration and management of automated resource-aware scheduling of SDDC upgrades.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for efficient configuration and management of automated resource-aware scheduling of upgrades across a plurality of software-defined data centers (SDDCs) According to certain embodiments, an optimized user interface provides controls configured to allow a user to centrally configure, monitor, and manage automatic assignments of phases of an upgrade across multiple SDDCs to time slots based on various constraints and/or resource availability information, including availability of physical computing resources and/or support resources.

An SDDC upgrade (e.g., involving an upgrade, patch, or other change to a service) may involve multiple phases to be performed on a plurality of SDDCs. In some cases, gaps may be needed between phases to avoid back-to-back maintenance operations on customer SDDCs. In one example, a workflow related to a rollout of an SDDC upgrade involves three phases on each given SDDC, including a first phase for upgrading installation files, a second phase for upgrading a control plane, and a third phase for upgrading hosts in the SDDC. A rollout generally comprises multiple waves and a plan to perform the upgrade on multiple SDDCs based on version, region, and/or the like. An upgrade manager, which may be a service running in a software-as-a-service (SaaS) layer, may orchestrate the rollout across the plurality of SDDCs. A user interface associated with the upgrade manager may allow a user to specify constraints, view related information, approve, reject, and/or modify automatically generated rollout schedules, and/or otherwise configure and manage rollout activities performed by the upgrade manager. In one embodiments, the upgrade manager determines rollout waves by dividing a plurality of SDDCs (e.g., which are eligible for the upgrade) into groups based on various criteria (e.g., organization type, region, risk level, and the like), with each group being referred to as a wave. Waves may be upgraded in a sequential manner, such as by upgrading all SDDCs in the first wave before upgrading all SDDCs in the second wave.

Support resource capacity may then be determined, such as based on availability information for support professionals. For example, such information may be defined in a support plan that indicates days and times on which support professionals are available, how many support professionals are available at those times, and the like. Support plans may be specified via the user interface. According to certain embodiments, the support plan is used to determine how many SDDCs can be upgraded at a given time with adequate support resources being available. For example, each day may be divided into twenty-four windows of one hour each that may be referred to as support windows, and the number of SDDCs that can be upgraded during a given support window may be referred to as a support window capacity. A set of contiguous support windows that have at least one available seat may be referred to as a maintenance window, which may have a length of one or more hours. The size of a maintenance window may refer to the number of support windows it contains.

According to certain embodiments described herein, each upgrade phase of an SDDC is assigned to a particular maintenance window, and the upgrade phase takes up one “seat” from the support windows in the particular maintenance window, reducing the available capacity of those support windows by one. For example, a maintenance window for a given phase may include multiple support windows (e.g., of one hour each). A maintenance window defines a start time and estimated completion time of a given upgrade phase assigned to the maintenance window. Automatic assignment of upgrade phases to maintenance windows may referred to as auto-placement. Auto-placement may be based on a variety of constraints and/or factors, such as physical computing resource availability, customer preferences, geographic preferences, and/or the like.

In one example, customers specify preferences regarding days and/or times on which upgrades should be performed and/or not performed. For example, a customer may specify that for a particular SDDC or group of SDDCs upgrades should preferably be performed on Saturdays and/or Sundays and should preferably not be performed on Wednesdays (e.g., Wednesday may be when the customer typically sees the highest amount of activity on these SDDCs each week). In another example, a particular geographic region may be associated with certain preferences, such as holidays common to that region or time windows that are more commonly active or inactive for that region. A regional preference for the United States may specify, for example, that upgrades should preferably be scheduled on July 4^{th} due to the national Independence Day holiday (e.g., because the SDDCs in this region are likely to experience less activity on this day). In one example, regional preferences may relate to common business hours in a given region, such as indicating a preference that upgrades being performed during non-business hours.

Customer and/or regional preferences may also include particular scheduled events, such as planned outages and/or other types of activities that would likely affect the ability of an upgrade to be completed successfully. For instance, if a customer has a product release scheduled for a particular day, the customer may indicate a preference that upgrades should not be performed on that day or even for the entire week or month during which the product release is scheduled.

In some embodiments, support plans and/or preferences such as customer and/or regional preferences are defined in one or more objects, such as javascript object notation (JSON) files. These objects may be received by the upgrade manager, which may utilize the information in the objects when performing auto-placement of upgrade phases in maintenance windows. In some embodiments, support plans and/or preferences such as customer and/or regional preferences may be received via a user interface.

The upgrade manager may also receive data indicating physical computing resource availability on SDDCs. Physical computing resources may include, for example, processing resources, memory resources, network resources, and/or the like. In some embodiments, historical physical computing resource utilization data from an SDDC is used to predict future physical computing resource utilization. For example, a machine learning model may be trained based on the historical data to predict future physical computing resource utilization for a given SDDC, such as based on historical physical computing resource utilization data from the same SDDC or from similar SDDCs (e.g., SDDCs having similar configurations). The predicted future physical computing resource utilization may be used during auto-placement, such as to schedule upgrade phases for times when physical computing resource utilization is predicted to be low.

In some embodiments, the upgrade manager automatically generates a schedule for a rollout that satisfies all constraints (e.g., including constraints specified via a user interface as described herein) as best as possible and maximizes available support and physical computing resources. One or more scores may be generated for a rollout schedule, such as based on whether support resources are under-utilized and/or over-utilized by the rollout schedule. Scores may then be used to select the best rollout schedule. For instance, the upgrade manager may generate a plurality of rollout schedules (e.g., random permutations that satisfy all constraints as best as possible and maximize resource availability), and choose the rollout schedule with the highest score. In certain embodiments, candidate rollout schedules and corresponding scores may be displayed to a user via a user interface, and the user may select a rollout schedule from the options displayed. For example, the user interface may provide the user with details about a proposed rollout schedule, including scheduled start times for particular rollout activities and scores for the proposed rollout schedule, which may allow the user to make informed determinations about whether to accept the proposed rollout schedule, or otherwise modify or reject the proposed rollout schedule. User interface controls may be configured to allow the user to efficiently accept, reject, or modify a proposed rollout schedule based on displayed details and/or to generate an alternative rollout schedule based on the same or different constraints.

For example, in some cases, the user interface allows a user (e.g., an administrator) to manage the initiation and scheduling of rollouts, such as by allowing the user to specify constraints and/or preferences, and presenting the user with candidate rollout schedules generated through auto-placement (e.g., along with scores such as over-utilization scores and under-utilization scores) and allowing the user to provide input confirming, denying, and/or changing the candidate rollout schedules.

Furthermore, in some embodiments, upgrade phases may be dynamically rescheduled as needed, such as based on detecting outages at specific SDDC regions. For example, if the upgrade manager determines that an outage is occurring with respect to a given SDDC, the upgrade manager may reschedule any scheduled upgrade phases for that SDDC that fall within a certain time window of the detected outage to a time outside of the time window.

In certain embodiments, durations of upgrade phases may be estimated based on past durations of upgrade phases, such as those with the same or similar attributes to the upgrade phases for which the durations are being estimated. For example, an average duration of all past similar upgrade phases for which historical data is available may be used as the estimated duration of a given upgrade phase. In some cases, machine learning may be used to estimate upgrade phase durations, such as by training a machine learning model based on past upgrade phase durations. Estimated upgrade phase durations may be used when assigning upgrade phases to maintenance windows, such as by assigning a given upgrade phase to a maintenance window of a size sufficient to support the estimated duration of the given upgrade phase (e.g., including a sufficient number of support windows, which may be one hour each, for the estimated duration of the given upgrade phase).

Techniques for automatically assigning upgrade phases to maintenance windows are described in more detail in U.S. patent application Ser. No. 17/644,272, the contents of which are incorporated herein by reference in their entirety. Embodiments of the present disclosure further allow efficient centralized configuration and management of such automated scheduling of rollout activities through particular user interface screens configured to provide optimized information and controls.

Embodiments of the present disclosure provide various improvements over conventional techniques for scheduling upgrades on multiple SDDCs. For example, techniques described herein for efficient configuration and management of automated resource-aware scheduling of SDDC upgrades avoid the time-consuming and error-prone process of manual schedule determination (e.g., through an automated process that is scalable across a potentially large number of SDDCs), provide for more dynamic upgrade scheduling through the use of particular constraints and resource availability information, and allow for more fine-grained control of such automated scheduling through optimized user interface screens. By allowing for fine-tuned scheduling of upgrade operations on SDDCs for times at which support resources are available and taking into account various constraints such as days and times at which SDDCs are expected to be particularly busy or downtime is most likely to be disruptive to ongoing processing, embodiments of the present disclosure improve the functioning of the computer systems involved by ensuring that upgrades are completed in a timely, orderly, and non-disruptive fashion. Certain embodiments involve the use of predicted physical computing resource utilization for SDDCs to optimize upgrade scheduling, such as by scheduling upgrade operations for times at which physical computing resource utilization is predicted to be otherwise low, thereby avoiding overutilization of physical computing resources, improving the functioning of computer systems in SDDCs, and reducing the business impact of upgrades to customers. Furthermore, the use of data intelligence such as for predicting durations of upgrade phases based on historical upgrade phase durations allows for more accurate estimations of completion times for upgrade phases, thereby allowing the resource-aware automated scheduling of upgrade phases to be more accurate and effective. Additionally, dynamic automated rescheduling of upgrade phases based on detected outages as described herein allows for a more resilient upgrade process in which real-time conditions are taken into account and adapted to.

Scoring of automatically-generated upgrade schedules based on resource underutilization and overutilization and displaying such scores in optimized user interface screens allows for the selection of an optimal upgrade schedule from multiple options through targeted user interface controls, thereby resulting in an improved automate schedule and, consequently, better functioning of the computer systems on which the upgrades are performed (e.g., due to better utilization of support and physical computing resources, upgrades that run more smoothly and complete sooner due to the availability of support resources, and the like). Furthermore, providing a user interface that allows for the management of SDDC upgrades as described herein provides improved orchestration of upgrades that span multiple SDDCs, allowing users to review and provide input related to the automated scheduling processes described herein in an optimized manner.

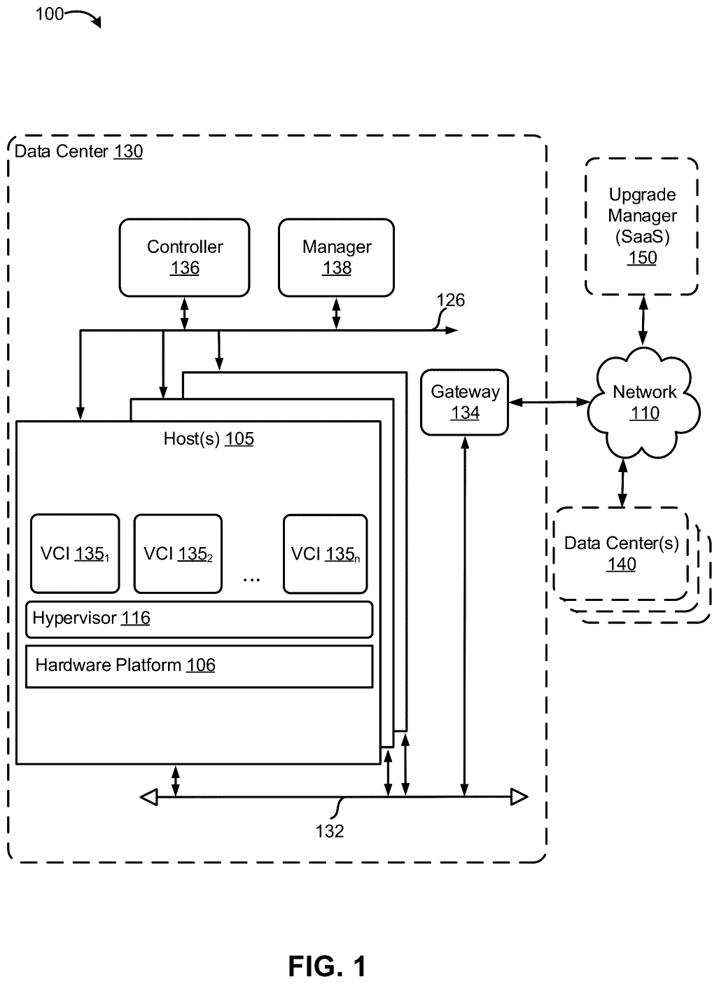

FIG. 1 depicts example physical and virtual network components with which embodiments of the present disclosure may be implemented.

Networking environment 100 includes data center 130 connected to network 110. Network 110 is generally representative of a network of machines such as a local area network (“LAN”) or a wide area network (“WAN”), a network of networks, such as the Internet, or any connection over which data may be transmitted.

Data center 130 generally represents a set of networked machines and may comprise a logical overlay network. Data center 130 includes host(s) 105, a gateway 134, a data network 132, which may be a Layer 3 network, and a management network 126. Host(s) 105 may be an example of machines. Data network 132 and management network 126 may be separate physical networks or different virtual local area networks (VLANs) on the same physical network.

One or more additional data centers 140 are connected to data center 130 via network 110, and may include components similar to those shown and described with respect to data center 130. Communication between the different data centers may be performed via gateways associated with the different data centers.

Each of hosts 105 may include a server grade hardware platform 106, such as an x86 architecture platform. For example, hosts 105 may be geographically co-located servers on the same rack or on different racks. Host 105 is configured to provide a virtualization layer, also referred to as a hypervisor 116, that abstracts processor, memory, storage, and networking resources of hardware platform 106 for multiple virtual computing instances (VCIs) 135₁ to 135ₙ (collectively referred to as VCIs 135 and individually referred to as VCI 135) that run concurrently on the same host. VCIs 135 may include, for instance, VMs, containers, virtual appliances, and/or the like. VCIs 135 may be an example of machines. For example, a containerized microservice may run on a VCI 135.

In certain aspects, hypervisor 116 may run in conjunction with an operating system (not shown) in host 105. In some embodiments, hypervisor 116 can be installed as system level software directly on hardware platform 106 of host 105 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 116 implements one or more logical entities, such as logical switches, routers, etc. as one or more virtual entities such as virtual switches, routers, etc. In some implementations, hypervisor 116 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Gateway 134 provides VCIs 135 and other components in data center 130 with connectivity to network 110, and is used to communicate with destinations external to data center 130 (not shown). Gateway 134 may be implemented as one or more VCIs, physical devices, and/or software modules running within one or more hosts 105.

Controller 136 generally represents a control plane that manages configuration of VCIs 135 within data center 130. Controller 136 may be a computer program that resides and executes in a central server in data center 130 or, alternatively, controller 136 may run as a virtual appliance (e.g., a VM) in one of hosts 105. Although shown as a single unit, it should be understood that controller 136 may be implemented as a distributed or clustered system. That is, controller 136 may include multiple servers or virtual computing instances that implement controller functions. Controller 136 is associated with one or more virtual and/or physical CPUs (not shown). Processor(s) resources allotted or assigned to controller 136 may be unique to controller 136, or may be shared with other components of data center 130. Controller 136 communicates with hosts 105 via management network 126.

Manager 138 represents a management plane comprising one or more computing devices responsible for receiving logical network configuration inputs, such as from a network administrator, defining one or more endpoints (e.g., VCIs and/or containers) and the connections between the endpoints, as well as rules governing communications between various endpoints. In one embodiment, manager 138 is a computer program that executes in a central server in networking environment 100, or alternatively, manager 138 may run in a VM, e.g. in one of hosts 105. Manager 138 is configured to receive inputs from an administrator or other entity, e.g., via a web interface or API, and carry out administrative tasks for data center 130, including centralized network management and providing an aggregated system view for a user.

According to embodiments of the present disclosure, one or more components of data center 130 may be upgraded, patched, or otherwise modified as part of a rollout that spans multiple data centers, such as data center 130 and one or more data centers 140. For example, an upgrade to virtualization infrastructure software may involve upgrading manager 138, controller 136, hypervisor 116, and/or one or more additional components of data center 130.

Upgrade manager 150 generally represents a service that manages upgrades across multiple data centers. For example upgrade manager 150 may perform operations described herein for automated resource-aware scheduling of SDDC upgrades. In some embodiments, upgrade manager 150 is a service that runs in a software as a service (SaaS) layer, which may be run on one or more computing devices outside of data center 130 and/or data center(s) 140, such as a server computer, and/or on or more hosts in data center 130 and/or data center(s) 140.

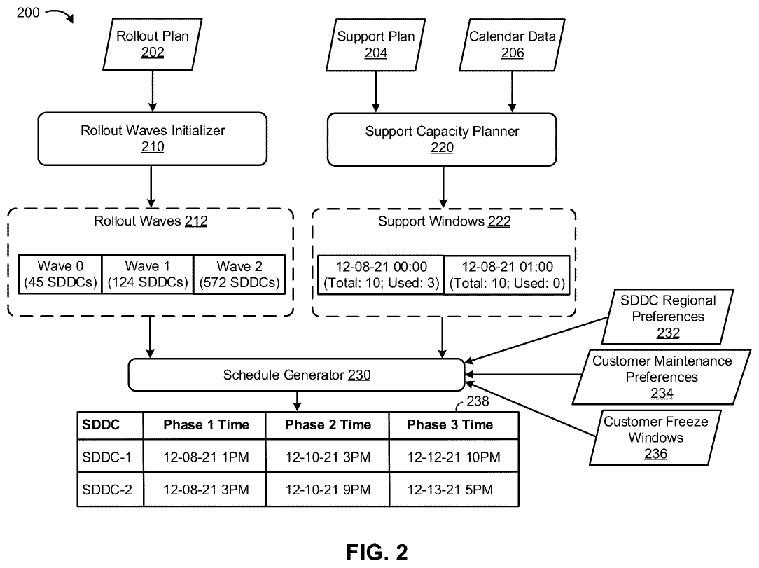

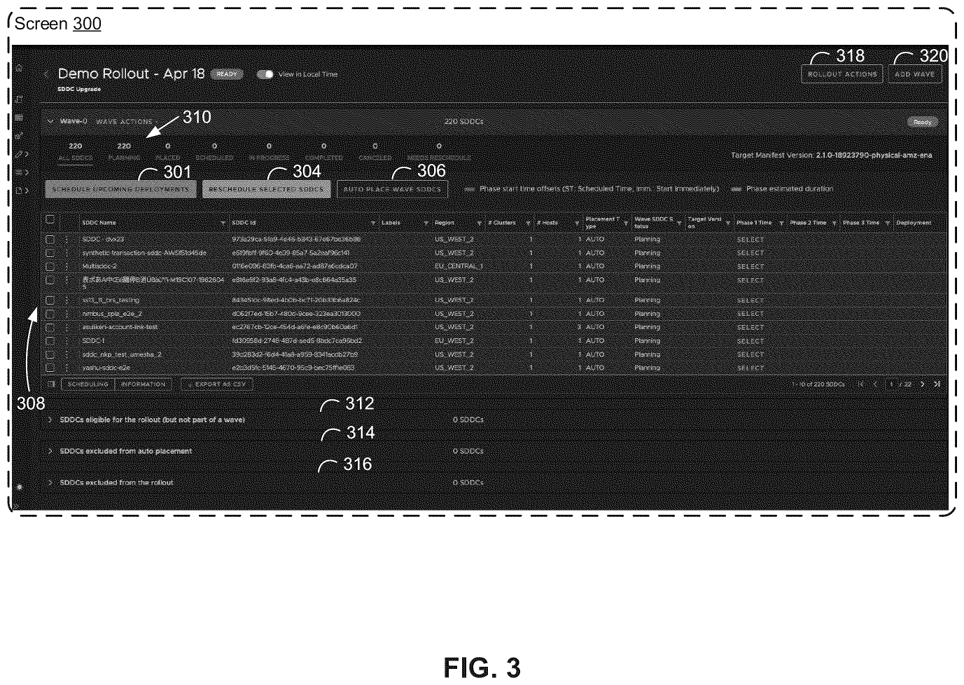

As described in more detail below with respect to FIG. 2, upgrade manager 150 may comprise a schedule generator that automatically generates a schedule for performing upgrade phases on multiple SDDCs. In some embodiments, as described in more detail below with respect to FIGS. 3-16, upgrade manager 150 provides an optimally configured user interface by which users can manage SDDC upgrades, such as providing constraints and preferences as well as reviewing and providing feedback with respect to automatically generated upgrade schedules, accepting automatically generated upgrade schedules, rejecting automatically generated upgrade schedules, or requesting re-generation of automatically generated upgrade schedules through targeted user interface controls.

FIG. 2 is an illustration 200 of an example related to automated resource-aware scheduling of software-defined data center (SDDC) upgrades. Illustration 200 includes rollout waves initializer 210, support capacity planner 220, and schedule generator 230, which may be components of upgrade manager 150 of FIG. 1.

A rollout plan 202 is received by rollout waves initializer 210. According to certain embodiments, rollout plan 202 is an object (e.g., a JSON object) or other type of document that defines waves of a rollout, with each wave including a group of one or more SDDCs that meet one or more criteria. In certain embodiments, the criteria may be defined by one or more users via a user interface. In one example, rollout plan 202 indicates that a first wave includes all internal customer SDDCs with more than 2 hosts, a second wave includes 40% of customer SDDCs with between 3 and 6 hosts, and a third wave includes all remaining customer SDDCs with 6 or more hosts. Rollout waves initializer generates rollout waves 212 based on rollout plan 202. Rollout waves 212 include a first wave (wave 0) with 45 SDDCs, a second wave (wave 1) with 124 SDDCs, and a third wave (wave 2) with 472 SDDCs. Aspects of rollout plan 202 may be based on user input received via one or more user interface screens described below with respect to FIGS. 3-16.

Support plan 204 and country-specific calendar data 206 are received by support capacity planner 220, which performs operations related to determining support windows as described herein. Support plan 204 may, for example, be an object (e.g., a JSON object) or other type of document that defines time slots during which support resources are available, such as support professionals capable of assisting with issues that may arise during rollouts. For each time slot, support plan 204 defines a capacity, which indicates a number of concurrent upgrades that can be supported by the available support resources. Country-specific calendar data 206 generally includes information about holidays and other days on which support resources are expected to be unavailable (e.g., regardless of whether such unavailability is indicated in support plan 204), which may be specific to particular countries or other regions. Thus, support capacity planner 220 may factor in the unavailable days indicated in country-specific calendar data 206 when determining support windows 222. Aspects of support plan 204 and calendar data 206 may be based on user input received via one or more user interface screens described below with respect to FIGS. 3-16.

Support capacity planner 220 uses support plan 204 and/or country-specific calendar data 206 to determine support windows 222. For instance, each day may be divided into twenty-four support windows of one hour each, and the number of SDDCs that can be upgraded during a given support window is the capacity of that support window. There are two example support windows depicted in support windows 222, including a first support window on Dec. 8, 2021 at 00:00 and a second support window on Dec. 8, 2021 at 01:00. The first support window has a capacity of 10, and 3 “seats” of this capacity are used. The second support window has a capacity of 10, and no seats of this capacity are used. A maintenance window may be a set of contiguous support windows that have at least one available seat, and the size of a maintenance window may be the number of support windows it contains. For example, a maintenance window may include both the first support window and the second support window in support windows 222.

Schedule generator 230 receives rollout waves 212 and support windows 222. Furthermore, schedule generator 230 receives SDDC regional preferences 232, customer maintenance preferences 234, and customer freeze windows 236. Aspects of SDDC regional preferences 232, customer maintenance preferences 234, and customer freeze windows 236 may be received via one or more user interface screens described below with respect to FIGS. 3-16.

SDDC regional preferences 232 generally include preferences associated with geographic regions in which SDDCs are located, and may include information such as holidays and other days on which downtime is expected in particular regions. Customer maintenance preferences 234 generally includes preferences specific to particular customers, and are applicable to the SDDCs associated with those customers. For example, customer maintenance preferences 234 may include indications of days and/or times at which certain customers prefer maintenance operations to be scheduled. Customer freeze windows 236 may indicate time windows during which operations will be frozen on SDDCs of customers, such as for other hardware or software maintenance operations, and during which no upgrades should be scheduled. In alternative embodiments, customer freeze windows 236 are part of customer maintenance preferences 234.

Furthermore, schedule generator 230 may receive additional constraints, such as a day on which the rollout is to begin and a target duration (e.g., number of days) for the rollout, such as via one or more user interface screens described below with respect to FIGS. 3-16.

Schedule generator 230 generates a schedule 238 based on rollout waves 212, support windows 222, SDDC regional preferences 232, customer maintenance preferences 234, customer freeze windows 236, and/or additional information (e.g., a day on which the rollout is to begin and a target duration for the rollout received via a user interface). Schedule 238 includes assignments of three phases of upgrades to two different SDDCs (SDDC-1 and SDDC-2) that are part of rollout waves 212 to particular maintenance windows that include one or more support windows 222 based on constraints and/or preferences, such as SDDC regional preferences 232, customer maintenance preferences 234, and/or customer freeze windows 236. Schedule generator 230 may also receive information related to physical computing resource availability on SDDCs, and may utilize this information when generating schedule 238. Schedule generator 230 produces an optimal placement of SDDC upgrade phases into the support windows such that all the constraints are satisfied. At the same time, schedule generator 230 produces a schedule that efficiently utilizes support resources to complete the entire rollout as soon as possible, such as through the use of scores that indicate an extent to which an automatically-generated scheduled over-utilizes and/or under-utilizes support resources.

In schedule 238, for SDDC-1, Phase 1 of the upgrade is scheduled for Dec. 8, 2021 at 12 AM, Phase 2 of the upgrade is scheduled for Dec. 10, 2021 at 3 PM, and Phase 3 of the upgrade is scheduled for Dec. 12, 2021 at 10 PM. For SDDC-2, Phase 1 of the upgrade is scheduled for Dec. 8, 2021 at 1 AM, Phase 2 of the upgrade is scheduled for Dec. 10, 2021 at 9 PM, and Phase 3 of the upgrade is scheduled for Dec. 13, 2021 at 5 PM.

An estimated completion duration (in hours) of an SDDC upgrade phase determines the size of a maintenance window required for placement of the phase. In some embodiments fixed values are used to determine estimated completion durations of upgrade phases, while in other embodiments machine learning techniques may be used to determine estimated completion durations. A maintenance window is represented by a set of contiguous support windows which have available capacity. The size of a maintenance window is the number of support windows it contains. For example, if Phase-1 of the SDDC-1 upgrade is estimated to take 6 hours to complete, then it can be placed into any maintenance window of size 6. In one example, there are 43 maintenance windows of size 6 or greater. Similarly, if Phase-1 of both of the SDDC-2 and SDDC-3 upgrades is estimated to take 9 hours, and there are 40 maintenance windows of size 9 or greater, then each of these phases can be placed in any of those 40 maintenance windows.

In this example, there are 68,800 (43*40*40) possible solutions for placing the phase-1 upgrades of the 3 SDDCs. This solution space becomes much larger considering possible placements including the other 2 phases. The auto-placement algorithm reduces the total possible solutions by filtering out all maintenance windows that violate placement constraints. Furthermore, the algorithm gives a score to each possible solution, called an auto-placement score, which is based on under-utilization and/or over-utilization of support windows. The algorithm explores different possible solutions using a local search optimization technique, for example generating an optimal solution which has the best auto-placement score. For example, the algorithm may involve starting with placing each phase in the first available maintenance window that will support that phase (or with a randomly-generated placement), calculating an auto-placement score for that placement, and then varying the placements and generating corresponding auto-placement scores for those placements. In some embodiments, if an auto-placement score for a particular placement falls below or exceeds a threshold, the algorithm stops and that placement is selected. In other embodiments, a number of placements are generated and the placement with the lowest or highest auto-placement score is selected.

Auto-placement scores are generally used by the algorithm to compare two possible placements. In some embodiments, a placement with a smaller score is better, as it represents a smaller amount of over-utilization and/or under-utilization of support resources. For example, an auto placement score may be defined by a support over-utilization score and a support under-utilization score as follows: auto_placement_score=(support_over_utlization_score, support_under_utilization_score). For example, support_over_utlization_score may be equal to the number of support window seats consumed beyond the available seats across all the given support windows. For example, if a support window has 3 seats available but the algorithm places 5 SDDCs into the support window, then the support_over_utlization_score of the support window is 2. The support_over_utilization score of a solution (e.g., a placement or schedule) is the sum of the over utilization scores of all the given support windows.

Similarly, support_under_utilization_score may be defined as the number of unused support window seats across all the given support windows. For example, if a support window has 10 seats available but the algorithm places 5 SDDCs into it, then the support_under_utilization_score of the support window is 5. The support_under_utilization_score of a solution is the sum of the under-utilization scores of all the given support windows.

In some embodiments, the algorithm first uses support_over_utlization_score to compare two solutions. For example, if one of the solutions has a lower support_over_utlization_score, then that solution may be selected regardless of the support_under_utilization_score. If two solutions have the same support_over_utlization_score, then support_under_utilization score may be used to compare the two solutions. In some embodiments, the best solution is the one with the smallest support_under_utilization_score. In other embodiments, both support_over_utilization_score and support_under_utilization_score are compared every time.

In some embodiments, one or more automatically generated schedules are displayed via a user interface along with auto-placement scores (e.g., the schedules may be ordered based on auto-placement score), and a user may select a schedule from those displayed or indicate that additional candidate schedules should be generated (e.g., if the user does not like any of the options presented). For example, if the user indicates that additional candidate schedules should be generated, then the auto-placement algorithm may be re-run one or more times to generate the additional candidate schedules. The user may also change one or more constraints (e.g., the day on which the rollout is to begin and/or the target duration of the rollout) before requesting that the auto-placement algorithm may be re-run via interaction with one or more user interface controls.

Constraints may relate to days and/or times for which upgrade phases should or should not be scheduled, physical computing resource availability, numbers of days within which upgrades should be completed (e.g., a constraint may indicate that a rollout should be completed within the next 30 days), when a rollout should begin, and/or the like.

Once a schedule has been selected, the upgrade phases may be scheduled for the days and times indicated in the schedule, and customers may be notified of when their SDDC upgrades are scheduled. Subsequently, the upgrade phases may be initiated at the scheduled times on the various SDDCs in order to implement the rollout.

In some embodiments, upgrade phases may be dynamically rescheduled in response to detected outages. For example, if an outage at a given SDDC is detected, and there is an upgrade phase scheduled presently or within the next one or more hours (e.g., within a fixed window), then that upgrade phase may be automatically rescheduled to a maintenance window outside of the next one or more hours.

As regional outages occur, outage events may be published to schedule generator 230, or API methods may be invoked to indicate the outages. As schedule generator 230 receives the events or other indications of outages, it filters out the SDDCs which are located in outage regions when scheduling upgrade phases, and re-schedules any upgrade phases for these SDDCs that fall within the outage windows (e.g., fixed time intervals or time intervals indicated in the outage events or indications) to new times outside the outage windows.

FIG. 3 depicts an example screen 300 related to configuration and management of automated resource-aware scheduling of SDDC upgrades. For example, screen 300 may be a screen of a user interface associated with upgrade manager 150 of FIG. 1.

Screen 300 generally represents a screen that displays information related to a rollout and includes controls for scheduling deployments and automated placements of SDDC upgrade waves. For example, a rollout may include a plurality of waves, each including a plurality of SDDCs, and screen 300 may include details of these waves and SDDCs.

Panel 308 includes details of multiple SDDCs that are to be upgraded as part of one or more waves of a rollout. For example, panel 308 includes information about each SDDC in a given wave (e.g., Wave-0), such as an SDDC name, SDDC identifier, any labels assigned to the SDDC, a region (e.g., indicating a geographic region), a number of clusters in the SDDC, a number of hosts in the SDDC, a placement type (e.g., automatic or manual), a wave SDDC status (e.g., indicating whether the SDDC is currently in a planning status, whether it has been placed, whether it has been scheduled, whether it has an upgrade in progress, whether the upgrade is complete for the SDDC, whether an upgrade of the SDDC has been canceled, whether the upgrade of the SDDC needs to be rescheduled, or the like), a target version (e.g., to which the SDDC is to be upgraded), a time at which a first phase is to start for the SDDC, a time at which a second phase is to start for the SDDC, a time at which a third phase is to start for the SDDC, a deployment indicator, and the like. In the example shown in screen 300, all of the SDDCs in Wave-0 are in a planning status, and have not yet been placed in maintenance windows.

Panel 310 includes particular information about the wave, such as a total number of SDDCs in the wave, a number of SDDCs that are in a planning status, a number of SDDCs that have been placed, a number of SDDCs that have been scheduled, a number of SDDCs that are in progress, a number of SDDCs that are completed, a number of SDDCs that have been canceled, a number of SDDCs that need to be rescheduled, and/or the like.

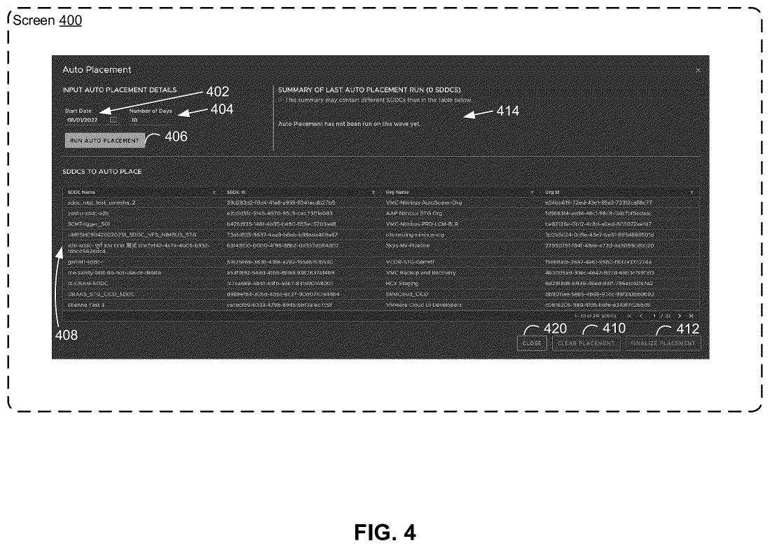

Screen 300 further includes a UI control 301 that, when selected, initiates a workflow for scheduling upcoming deployments. Screen 300 further includes a UI control 304 that, when selected, initiates a workflow for rescheduling one or more SDDCs (e.g., one or more SDDCs that have been selected by the user within panel 308). Screen 300 further includes a UI control 306 that, when selected, initiates a workflow for automatically placing the SDDCs of the wave in one or more maintenance windows. Selecting UI control 206 may result in screen 400 of FIG. 4 being displayed.

Screen 300 further includes a panel 312 indicating how many SDDCs are eligible for the rollout but are not part of a wave, a panel 314 indicating how many SDDCs are excluded from auto placement, and a panel 316 indicating how many SDDCs are excluded from the rollout. Selecting a control associated with each of panels 312, 314, and 316 may cause the respective panel to expand and display additional details about the SDDCs indicated in the panel, such as the identifiers of the relevant SDDCs.

Screen 300 further includes UI control 318 that, when selected, causes rollout actions to be displayed, such as a list of possible actions that can be performed for the rollout. Screen 300 further includes UI control 320 that, when selected, initiates a workflow for adding a wave to the rollout.

FIG. 4 depicts another example screen 400 related to configuration and management of automated resource-aware scheduling of SDDC upgrades. For example, screen 400 may be a screen of a user interface associated with upgrade manager 150 of FIG. 1.

Screen 400 generally represents a screen that allows a user to configure and manage an automated placement of wave SDDCs in maintenance windows. For example, screen 400 may be displayed after a user selects UI control 306 of FIG. 3. In one example, screen 400 is displayed on top of, within, or as a separate new screen from screen 300.

Screen 400 includes field 402 that is configured to receive user input specifying a start date for the wave, and field 404 that is configured to receive user input specifying a target duration for the wave, such as a number of days within which the wave should be completed.

Screen 400 further includes a panel 414 that includes a summary of a most recent auto placement run for the wave, including a number of SDDCs that were included in the most recent auto placement run and other information. In the example shown in screen 400, panel 414 indicates that auto placement has not been run yet for this wave.

Screen 400 further includes panel 408, which lists details of the SDDCs in the wave. For example, panel 408 may display, for each SDDC in the wave, an SDDC identifier, an organization name for an organization associated with the SDDC, an organization identifier for the organization associated with the SDDC, and the like.

Screen 400 further includes a UI control 420 that, when selected, causes screen 400 to close (e.g., causing the user interface to return to screen 300). Screen 400 further includes UI control 410 that, when selected, causes an auto placement to be cleared (e.g., rejected) and UI control 412 that, when selected, causes an auto placement to be finalized (e.g., accepted). In the example shown in screen 400, UI controls 410 and 412 cannot yet be selected, as no auto placement has been run. For example, UI controls 410 and 412 may be visually de-emphasized (e.g., via color, transparency, or some other indicator) in order to indicate that these controls cannot yet be selected.

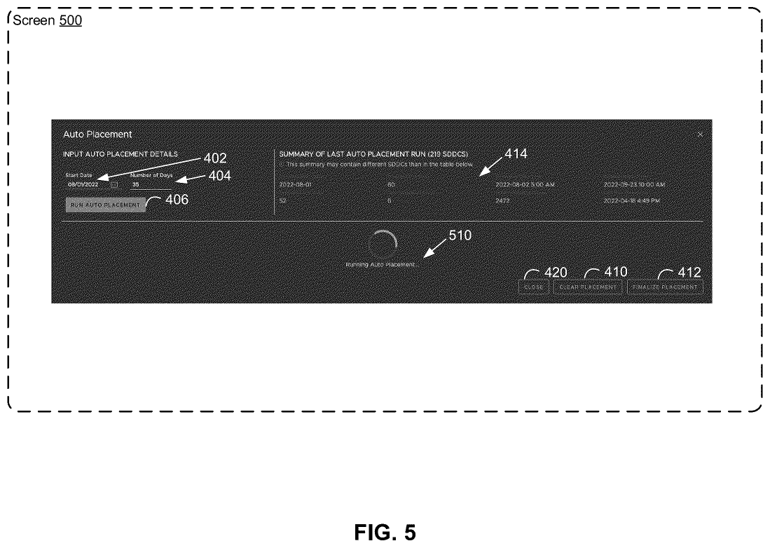

Screen 400 further includes UI control 406 (e.g., “run auto placement”) that, when selected, causes an auto placement to be run according to the constraints provided via fields 402 and 404. For example, if the user has provided a start date of Aug. 1, 2022 via field 402 and a target duration of 10 days via field 404, then selecting UI control 406 will initiate an auto placement of the wave that begins on Aug. 1, 2022 and is completed within 10 days. Logic of the auto placement algorithm is described above with respect to FIGS. 1 and 2 and in U.S. patent application Ser. No. 17/644,272. Selecting UI control 506 may cause screen 500 of FIG. 5 to be displayed.

FIG. 5 depicts another example screen 500 related to configuration and management of automated resource-aware scheduling of SDDC upgrades. For example, screen 500 may be a screen of a user interface associated with upgrade manager 150 of FIG. 1.

Screen 500 generally represents a changed version of screen 400 after a user selects UI control 406 of FIG. 4 in order to run an auto placement. In one example, screen 400 transitions to screen 500. Screen 500 includes fields 402 and 404, panel 414, and UI controls 406, 410, 412, 420 of screen 400. In the example shown in screen 500, a status indicator 510 indicates that auto placement is being run, such as showing an animation or other indicator along with text indicating that auto placement is in progress. While auto placement is being run, none of controls 406, 410, 412, or 420 can be selected.

In screen 500, panel 414 indicates details of the auto placement that was most previously run (e.g., the run currently in progress or an intermediate run in an alternative embodiment), showing the number of SDDCS in the auto placement, the provided start date, the provided target duration (e.g., number of days), an estimated start time for the wave, an estimated duration for the wave, an overutilization score, an underutilization score, and a timestamp of the last auto placement run. In another example, panel 414 may include the same information from screen 400 (e.g., indicating that no auto placement has been run yet for the wave) while the auto placement run is in progress.

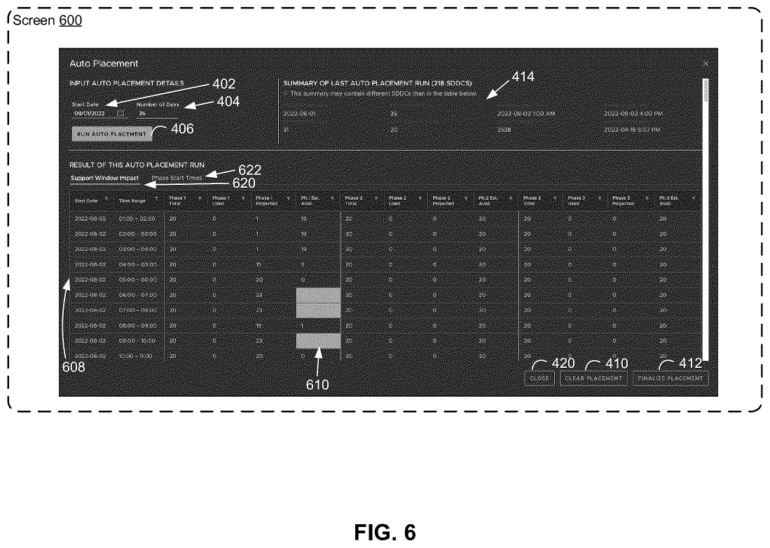

When the auto placement run completes, screen 600 of FIG. 6 may be displayed.

FIG. 6 depicts another example screen 600 related to configuration and management of automated resource-aware scheduling of SDDC upgrades. For example, screen 600 may be a screen of a user interface associated with upgrade manager 150 of FIG. 1.

Screen 600 generally represents a changed version of screen 500 after the auto placement run has completed. In one example, screen 500 transitions to screen 600. Screen 600 includes fields 402 and 404, panel 414, and UI controls 406, 410, 412, 420 of screens 400 and 500. In the example shown in screen 600, a panel 608 displays details of the auto placement that was run. For example, panel 608 shows the support window impact of the auto placement run because option 620 is currently selected. In some embodiments, if option 622 is selected, panel 608 will display the phase start times instead of the support window impact.

The support window impact information (e.g., indicating the extent to which a plurality of support windows are utilized by the auto placement) displayed in panel 608 includes, for each support window, a start date for the support window, a time range for the support window (e.g., a range of hours), a number of maintenance windows in each phase of the support window (e.g., in this case, phase 1, phase 2, and phase 3), a number of used maintenance windows in each phase of the support window, a number of maintenance windows that are projected to be used in each phase of the support window, and an estimated number of available maintenance windows in each phase of the support window (e.g., after the projected number of maintenance windows have been used for the phase). Panel 308 may display an alert for each support window that has a negative number of estimated available maintenance windows in at least one phase (e.g., indicating that the support window is being over-utilized), such as alert 610. Such an alert may displayed in many different formats, such as highlighting the negative number, changing formatting of the negative number changing a color associated with display of the negative number, displaying text or a notification box, and/or the like.

In screen 600, panel 414 indicates details of the auto placement that was most previously run (e.g., the run for which the support window impact is being displayed in panel 608), showing the number of SDDCS in the auto placement, the provided start date, the provided target duration (e.g., number of days), an estimated start time for the wave, an estimated duration for the wave, an overutilization score, an underutilization score, and a timestamp of the last auto placement run.

Selecting UI control 410 may cause the auto placement run for which details are currently displayed to be cleared or otherwise discarded. Selecting UI control 412 may cause the auto placement run to be finalized, such as causing the wave to be scheduled and causing customers to be notified of the scheduled upgrade activities, as described above. The wave may then take place, with the SDDCs in the wave being upgraded during the maintenance windows within which they were placed by the auto placement run.

Alternatively, the user may select UI control 406 again to re-run the auto placement algorithm, such as to generate an alternative auto placement. In some embodiments, the user may edit one or more constraints, such as via fields 402 or 404, prior to selecting UI control 406 to re-run the auto placement algorithm. Selecting UI control 406 may cause a new auto placement run to initiate, such as causing screens similar to screens 500 and 600 to be displayed again in succession (e.g., with details of the new auto placement run being displayed).

The details displayed in screen 600 (and other UI screens described herein) may allow the user to make informed decisions and exercise fine-grained control over the auto placement algorithm, such as providing and revising constraints as needed and selecting individual SDDCs or waves to edit, re-run auto placement for, or manually schedule. For example, the information displayed in screen 600 may inform a user about how optimally a given auto placement utilizes available support windows. In one example, the user may determine based on the information displayed in screen 600 (e.g., in panel 608 and/or panel 414) that too many support windows are being over-utilized by the auto placement (e.g., based on the over-utilization score of 20 displayed in panel 414), and may decide to increase the target duration of the auto placement by providing a different number of days via field 404. The user may then select UI control 406 again to initiate re-running of the auto placement algorithm based on the updated target duration.

It is noted that the phases may correspond to different software components that are upgraded in a given wave. For example, a virtualization manager may be upgraded in phase 1, a hypervisor may be upgraded in phase 2, a network manager may be upgraded in phase 3, and so on (e.g., the number of phases may be configurable). Furthermore, waves can relate to any kind of maintenance operations and phases within waves can relate to any sort of subsets of maintenance operations to be performed within the waves.

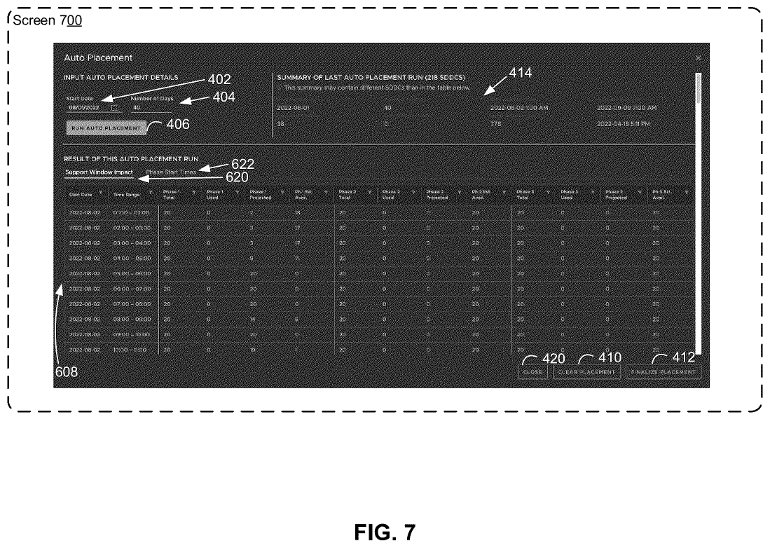

FIG. 7 depicts another example screen 700 related to configuration and management of automated resource-aware scheduling of SDDC upgrades. For example, screen 700 may be a screen of a user interface associated with upgrade manager 150 of FIG. 1.

Screen 700 generally represents a changed version of screen 600 after an auto placement re-run has completed. In one example, screen 600 transitions to screen 700 after the user inputs a new target duration (changing 35 days to 40 days) via field 404 and then selects UI control 406 to re-run the auto placement. Screen 600 includes fields 402 and 404, panel 414, and UI controls 406, 410, 412, 420 of screens 400 and 500, and panel 608 of screen 600. In the example shown in screen 700, panels 608 and 414 have been updated to display details of the new auto placement that was run. For example, panel 608 shows the support window impact of the auto placement run because option 620 is currently selected. In some embodiments, if option 622 is selected, panel 608 will display the phase start times instead of the support window impact.

As shown in screen 700, panel 414 now shows an over-utilization score of 0, and there are no alerts shown in panel 608. Thus, the user may choose to accept the auto placement, such as by selecting UI control 412 to finalize placement.

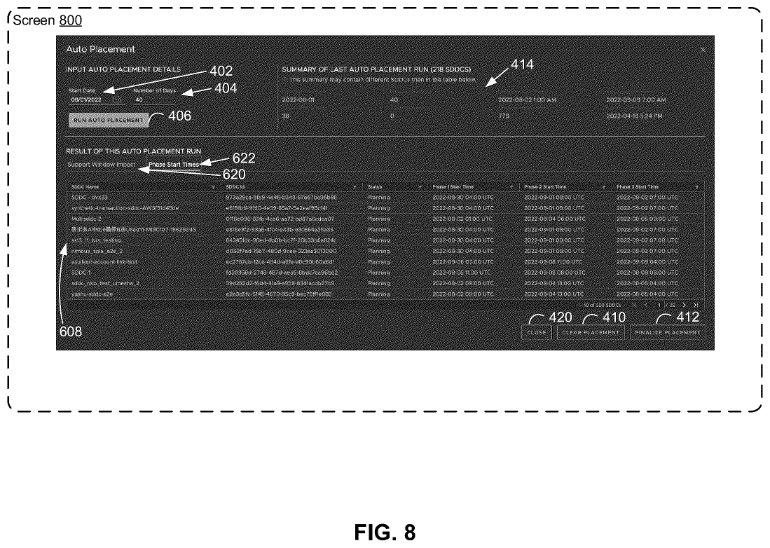

FIG. 8 depicts another example screen 800 related to configuration and management of automated resource-aware scheduling of SDDC upgrades. For example, screen 800 may be a screen of a user interface associated with upgrade manager 150 of FIG. 1.

Screen 800 generally represents a changed version of screen 700 after the user has selected option 622 to switch to viewing the phase start times within panel 608. In one example, screen 700 transitions to screen 800 after the user selects option 622.

When option 622, is selected, panel 608 shows information that includes phase start times for each phase for each SDDC of the wave. For example, panel 608 includes, for each SDDC in the wave, an SDDC identifier, a status of the SDDC (e.g., planning, places, scheduled, completed, canceled, needs re-schedule, or the like), and a start time for each phase for the SDDC. In the example shown, for the first SDDC in the list, phase 1 has a start time of “2022 Aug. 30 04:00 UTC,” phase 2 has a start time of “2022 Sep. 1 08:00 UTC,” and phase 3 has a start time of “2022 Sep. 2 07:00 UTC.”

If the user selects UI control 412 to finalize placement, either from screen 700 or screen 800, then the user interface may return to screen 300 of FIG. 3, such as changing the information in panel 308 of FIG. 3 to include details of the finalized placement (e.g., changing the status of each SDDC in the wave to “placed” and showing the phase start times for each SDDC according to the finalized placement). The user may then select UI control 301 of FIG. 3 to schedule upcoming deployments, which may cause the upgrades of the SDDCs in the wave to be scheduled according to the finalized placement and, in some embodiments, may cause customers to be notified of the scheduled upgrade activities. The user may also select individual SDDCs via panel 308 of FIG. 3 and then select UI control 304 to reschedule those selected SDDCs, which may initiate a workflow to either manually reschedule those SDDCs or perform an alternative automated placement/rescheduling for the SDDCs.

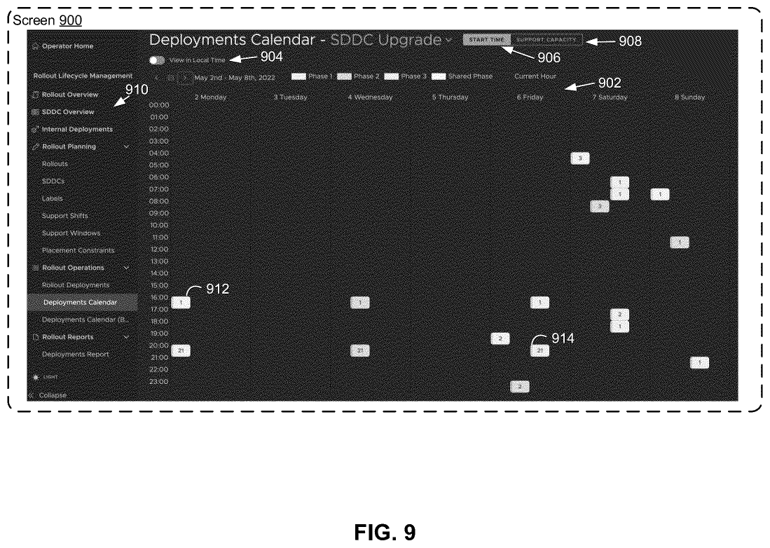

FIG. 9 depicts another example screen 900 related to configuration and management of automated resource-aware scheduling of SDDC upgrades. For example, screen 900 may be a screen of a user interface associated with upgrade manager 150 of FIG. 1.

Screen 900 generally represents a deployments calendar view by which a user may view scheduled deployments (e.g., which may have been scheduled by selecting UI control 301 of FIG. 3) within a calendar view. Screen 900 may be accessed via a navigation menu 910 that allows the user to navigate through different screens.

A panel 902 of screen 900 shows a series of calendar days (e.g., in this example, a single Monday-Friday week of calendar days is displayed) with a timeline showing the hours of each of the calendar days and UI elements (e.g., UI elements 912 and 914) showing how many SDDC upgrades, if any, are scheduled for each hour. For example, UI element 912 indicates that one phase 1 SDDC upgrade is scheduled for the hour between 16:00 and 17:00 on Monday, May 8, 2022 and UI element 914 indicates that 21 phase 3 SDDC upgrades are scheduled for the hour between 20:00 and 21:00 on Friday, May 6, 2022. Colors or other attributes of these UI elements may indicate which phase these scheduled SDDC upgrades correspond to (e.g., in this example the color of each UI element may indicate whether the indicated SDDC upgrade at a given hour is for phase 1, phase 2, phase 3, or a shared phase). Furthermore, a given UI element within the panel may indicate the current hour in some embodiments (not shown).

A UI control 904 may allow the user to toggle on and off an option of viewing times in local time (e.g., a local time zone for the user).

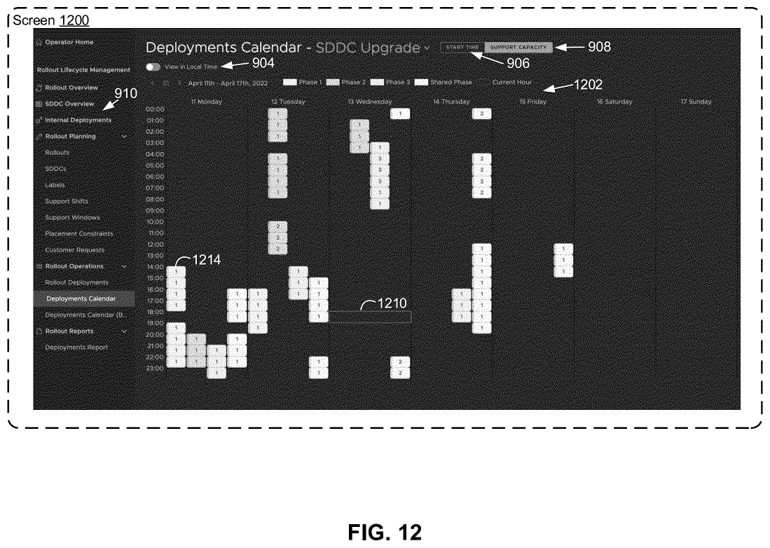

Options 906 and 908 allow the user to change the information displayed in panel 902, with option 906 causing SDDC upgrade start times to be displayed in panel 902 and option 908 causing support capacity information to be displayed in panel 908. In screen 900, option 906 has been selected, and so start times are displayed in panel 902. If the user selects option 908, screen 1200 of FIG. 12 may be displayed instead.

A user may determine based on panel 200 that support professionals should expect to be available and on high alert for the hour between 20:00 and 21:00 on Monday, May 2, Wednesday, May 4, and Friday, May 6, because UI elements (e.g., UI element 914) indicate that a large number of SDDCs will be upgraded at these times.

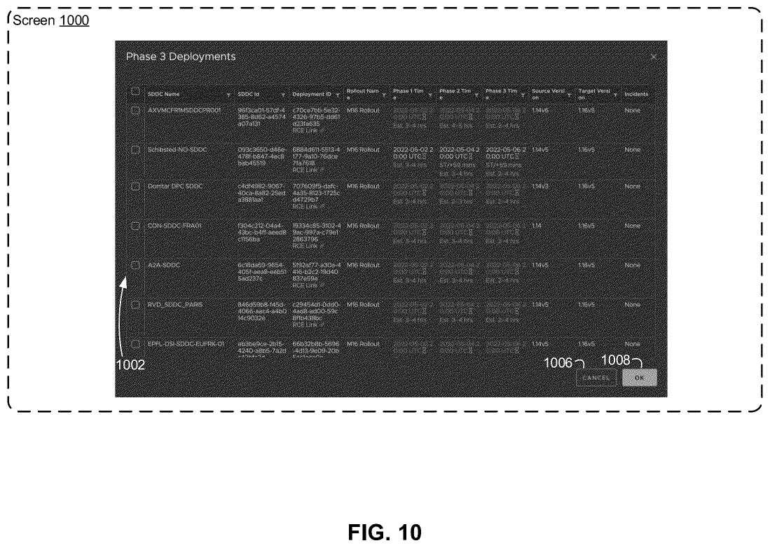

Selecting UI elements in panel 902, such as UI elements 912 and 914, may cause additional details about the scheduled SDDC upgrades indicated by the UI elements to be displayed. For example, selecting UI element 914 may cause screen 1000 of FIG. 10 to be displayed.

FIG. 10 depicts another example screen 1000 related to configuration and management of automated resource-aware scheduling of SDDC upgrades. For example, screen 1000 may be a screen of a user interface associated with upgrade manager 150 of FIG. 1.

Screen 1000 generally represents a detailed view of phase deployments. For example, screen 1000 may be launched by selecting a UI element (e.g., UI element 914) of screen 900 of FIG. 9

Screen 1000 includes a panel 1002 that displays information about each SDDC that is scheduled to be upgraded (e.g., in a certain phase) for a selected hour. For example, if UI element 914 was selected, screen 1000 includes details about the hour from 20:00 to 21:00 on Friday, May 6, 2022. Panel 1002 includes, for each applicable SDDC, an SDDC name, an SDDC identifier, a deployment identifier, a rollout name, a start time for one or more phases for the SDDC, a source version (from which the SDDC is being upgraded), a target version (e.g., to which the SDDC is being upgraded), and an indication of any incidents that have occurred in connection with the upgrade. While screen 1000 is primarily focused on displaying information about the phase 3 upgrades scheduled for the hour from 20:00 to 21:00 on Friday, May 6, 2022 (e.g., because the user selected UI element 914 of FIG. 9), panel 1002 also includes information about the other phases for each of the SDDCs, such as showing the day and time at which phase 1 and phase 2 are scheduled for each given SDDC.

Screen 1002 includes a UI control 1006 (“cancel”) that initiates a workflow for canceling the scheduled deployments for the phase and a UI control 1008 (“ok”) that accepts the displayed information (e.g., causing screen 1000 to be closed and causing the UI to return to screen 900 of FIG. 9).

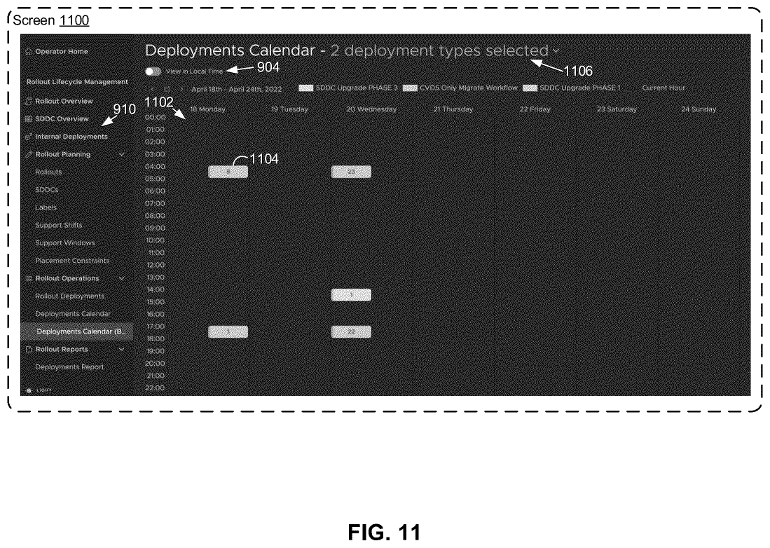

FIG. 11 depicts another example screen 1100 related to configuration and management of automated resource-aware scheduling of SDDC upgrades. For example, screen 1100 may be a screen of a user interface associated with upgrade manager 150 of FIG. 1.

Screen 1100 generally represents a detailed view of multiple types of deployments. For example, screen 1100 may be accessed via navigation menu 910 of FIG. 9, and may be similar to screen 900 of FIG. 9 except that, while screen 900 of FIG. 9 shows details only of SDDC upgrades, screen 1100 shows details of multiple types of deployments including SDDC upgrades as well as converged virtual distributed switch (CVDS) migration workflows. It is noted that SDDC upgrades and CVDS migration workflows are included as examples, and other types of deployments may also be managed using screens described herein.

A panel 1102 of screen 1100 shows a series of calendar days (e.g., in this example, a single Monday-Friday week of calendar days is displayed) with a timeline showing the hours of each of the calendar days and UI elements (e.g., UI element 1104) showing how many SDDC upgrades or CVDS migrataions, if any, are scheduled for each hour. For example, UI element 1104 indicates that nine CVDS migrations are scheduled for the hour between 04:00 and 05:00 on Monday, May 18, 2022. Colors or other attributes of these UI elements may indicate which SDDC upgrade phase the UI elements correspond to or whether the UI elements correspond to CVDS migration workflows (e.g., in this example the color of each UI element may indicate whether the indicated UI element at a given hour is an SDDC upgrade phase 3, an SDDC upgrade phase 1, or a CVDS migration workflow). Selecting UI elements, such as UI element 1104, may cause a screen similar to screen 1000 of FIG. 10 to be displayed, providing details of the SDDC upgrades or SVDS migrations corresponding to the selected UI element.

FIG. 12 depicts another example screen 1200 related to configuration and management of automated resource-aware scheduling of SDDC upgrades. For example, screen 1200 may be a screen of a user interface associated with upgrade manager 150 of FIG. 1.

Screen 1200 generally represents an alternative version of the deployments calendar view shown in screen 900 of FIG. 9. Screen 1200 may be accessed via a navigation menu 910 and/or by selecting option 908 (e.g., as opposed to option 906, which is selected in screen 900 of FIG. 9).

A panel 1202 of screen 1200, like panel 902 of FIG. 9, shows a series of calendar days (e.g., in this example, a single Monday-Friday week of calendar days is displayed) with a timeline showing the hours of each of the calendar days and UI elements (e.g., UI element 1214) showing how much support capacity, if any, has been consumed by scheduled deployments for each hour. For example, UI element 1214 indicates that one support window has been consumed by a phase 1 SDDC upgrade that is scheduled for the hour between 14:00 and 15:00 on Monday, May 11, 2022. Colors or other attributes of these UI elements may indicate which phase these scheduled SDDC upgrades correspond to (e.g., in this example the color of each UI element may indicate whether the indicated SDDC upgrade at a given hour is for phase 1, phase 2, phase 3, or a shared phase). Furthermore, a given UI element within the panel may indicate the current hour. For example, UI element 1218 indicates the current hour (e.g., the hour between 18:00 and 19:00 on Wednesday, May 13, 2022).

UI control 904 may allow the user to toggle on and off an option of viewing times in local time (e.g., a local time zone for the user).

Options 906 and 908 allow the user to change the information displayed in panel 902, with option 906 causing SDDC upgrade start times to be displayed in panel 902 and option 908 causing support capacity information to be displayed in panel 908. In screen 1200, option 906 has been selected, and so support capacity information is displayed in panel 1102. If the user selects option 908, screen 900 of FIG. 9 may be displayed instead.

Selecting UI elements in panel 1202, such as UI element 1214, may cause additional details about the scheduled SDDC upgrades indicated by the UI elements to be displayed. For example, selecting UI element 1214 may cause a screen similar to screen 1000 of FIG. 10 to be displayed.

Screen 1200 helps a user to determine the concurrency levels of scheduled deployments, such as for planning purposes. In one example, a user may utilize screen 1200 to identify unused support windows, such as to manually schedule an upgrade for such an unused support window. While screen 900 of FIG. 9 shows only the hour at which a given SDDC upgrade is scheduled to start, screen 1200 also shows the estimated duration (e.g., in hours) of each SDDC upgrade, such as by indicating a series of hours that will have one or more support windows occupied by one or more given SDDC upgrades.

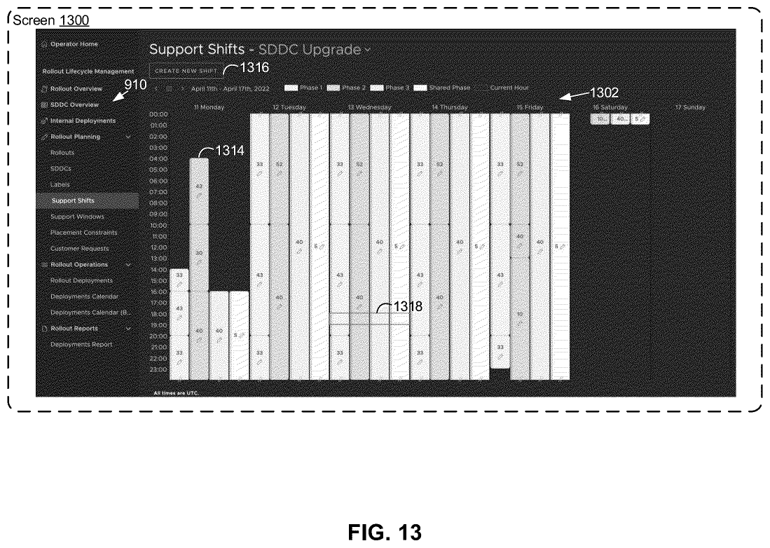

FIG. 13 depicts another example screen 1300 related to configuration and management of automated resource-aware scheduling of SDDC upgrades. For example, screen 1300 may be a screen of a user interface associated with upgrade manager 150 of FIG. 1.

Screen 1300 generally represents a calendar view of support shifts. Screen 1300 may be accessed via navigation menu 910.

A panel 1302 of screen 1300 shows a series of calendar days (e.g., in this example, a single Monday-Friday week of calendar days is displayed) with a timeline showing the hours of each of the calendar days and UI elements (e.g., UI element 1314) showing how many support shifts, if any, have been consumed by scheduled deployments for each hour or series of hours. For example, UI element 1314 indicates that forty-two support window have been consumed by phase 2 SDDC upgrades that are scheduled for the hours between 04:00 and 10:00 on Monday, May 11, 2022. Colors or other attributes of these UI elements may indicate which phase these scheduled SDDC upgrades correspond to (e.g., in this example the color of each UI element may indicate whether the indicated SDDC upgrade(s) represented by a given UI element are for phase 1, phase 2, phase 3, or a shared phase). Furthermore, a given UI element within the panel may indicate the current hour. For example, UI element 1318 indicates the current hour (e.g., the hour between 18:00 and 19:00 on Wednesday, May 13, 2022).

Screen 1300 allows a user to view and manage the availability of support professionals capable of assisting with upgrade activities. For example, a support shift may indicate a window of time during which one or more support professionals are available. The information in screen 1300 may assist a user with scheduling upgrade activities for times when adequate support will be available to help with any issues that may arise.

UI control 1316, when selected, initiates a workflow for creating a new support shift. For example, upon selecting UI control 1316, the user may be provided with a UI screen (not shown) that allows the user to create a new support shift, such as including UI elements and controls that allow the user to specify a date/time range for the support shift and a number of support professionals that will be available for the support shift.

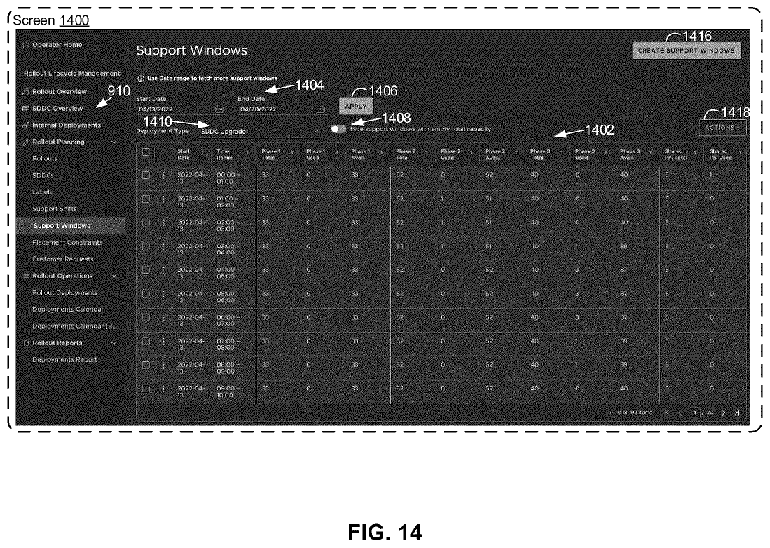

FIG. 14 depicts another example screen 1400 related to configuration and management of automated resource-aware scheduling of SDDC upgrades. For example, screen 1400 may be a screen of a user interface associated with upgrade manager 150 of FIG. 1.

Screen 1400 generally represents a detail view of support windows. Screen 1400 may be accessed via navigation menu 910.

A panel 1402 of screen 1400 shows details of one or more support windows, such as all support windows that fall within a range of dates specified by the user via fields 1404 (e.g., by which a user may enter a start date and an end date) and that correspond to a deployment type selected via UI control 1410 (e.g., which allows the user to specify the deployment type for which the user would like to view support windows, such as SDDC upgrades, CVDS migrations, other types of upgrades or migrations, and/or the like). The user may have selected UI control 1406 to apply the date range entered via fields 1404 (e.g., causing panel 1402 to be updated with the information corresponding to the applied date range). Furthermore, screen 1400 includes a toggle 1408 that, when toggled on, hides support windows with an empty total capacity (e.g., causing such support windows not to be shown in panel 1402).

For each applicable support window, the information displayed in panel 1402 may include a start date, a time range, a total number of seats for each phase in the support window, a number of used seats for each phase of the support window, and a number of available seats for each phase of the support window. The information may also include, for each support window, a total number of seats for a shared phase in the support window, a number of used seats for a shared phase of the support window, and a number of available seats for a shared phase of the support window.

Screen 1400 further includes a UI control 1416 that, when selected, initiates a workflow for creating new support windows. For example, upon selecting UI control 1416, the user may be provided with a UI screen (not shown) that allows the user to create a new support window, such as including UI elements and controls that allow the user to specify a date/time range for the support window and a number of seats in the support window for different phases.

Screen 1400 may further include a UI control 1418 that, when selected, allows the user to select from multiple actions that can be performed with respect to a support window (e.g., a support window that has been selected within panel 1402), such as editing the support window, deleting the support window, placing upgrading activities within the support window, and/or the like.

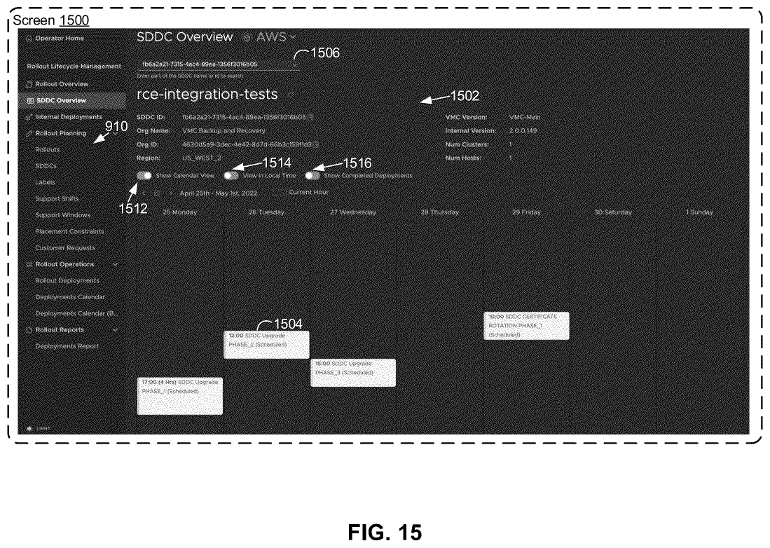

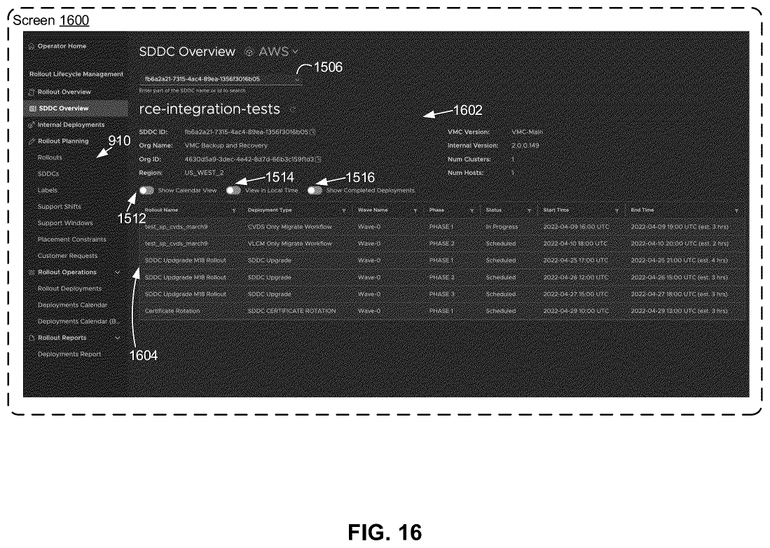

FIG. 15 depicts another example screen 1500 related to configuration and management of automated resource-aware scheduling of SDDC upgrades. For example, screen 1500 may be a screen of a user interface associated with upgrade manager 150 of FIG. 1.

Screen 1500 generally represents an SDDC overview page. Screen 1500 may be accessed via navigation menu 910.

A panel 1502 of screen 1500 shows details of a particular SDDC, such as an SDDC identifier, an organization name of an organization associated with the SDDC, an organization identifier of the organization associated with the SDDC, a region associated with the SDDC, a version associated with the SDDC, an internal version associated with the SDDC, a number of clusters in the SDDC, and a number of hosts in the SDDC. Panel 1502 further includes a calendar view (e.g., in this case a view of days in a Monday-Friday week) showing upgrade phases that are scheduled for the SDDC on particular days (e.g., indicating the time of day at which these upgrades are scheduled). UI elements in the calendar view of panel 1502 indicate particular SDDC upgrade phases scheduled at particular times on particular days for the SDDC, such as UI element 1504, which indicates that a phase 2 upgrade is scheduled for the SDDC at 12:00 on Tuesday, Apr. 26, 2022. As in other part of the present disclosure, upgrades are included as an example, and other types of maintenance operations may also be scheduled, viewed, and managed using UI screens described herein.

A toggle 1512 allows the user to toggle the calendar view on and off, another toggle 1514 allows the user to toggle on and off viewing times in local time, and another toggle 1516 allows the user to toggle on and off showing completed deployments. For example, toggling off the calendar view via toggle 1512 may cause a tabular view to be displayed, such as screen 1600 of FIG. 16. Toggling on toggle 1516 may hide all completed deployments from being displayed in the calendar view of panel 1502.

A UI control 1506 allows the user to select an SDDC, such as by selecting an SDDC name from a list or otherwise providing a name or identifier of an SDDC. The SDDC that is identified via UI control 1506 is the SDDC about which information is displayed in panel 1502. The user may switch between viewing information about different SDDCs via UI control 1506.

FIG. 16 depicts another example screen 1600 related to configuration and management of automated resource-aware scheduling of SDDC upgrades. For example, screen 1600 may be a screen of a user interface associated with upgrade manager 150 of FIG. 1.

Screen 1600 generally represents an SDDC overview page with a tabular view (e.g., as opposed to the calendar view shown in screen 1500 of FIG. 15). Screen 1600 includes navigation menu 910, UI control 1506, and toggles 1512, 1514, and 1516 of FIG. 15. For example, screen 1500 may transition to screen 1600 when toggle 1512 is toggled off (e.g., turning off the calendar view).

Tabular view 1604 includes a tabular view of each upgrade (or other maintenance) operation that is scheduled for the SDDC, such as including, for each such operation, a rollout name, a deployment type (e.g., SDDC upgrade, CVDS migration, and/or the like), a wave name, a phase, a status (e.g., scheduled, in progress, completed, and/or the like), a start time, and an end time.

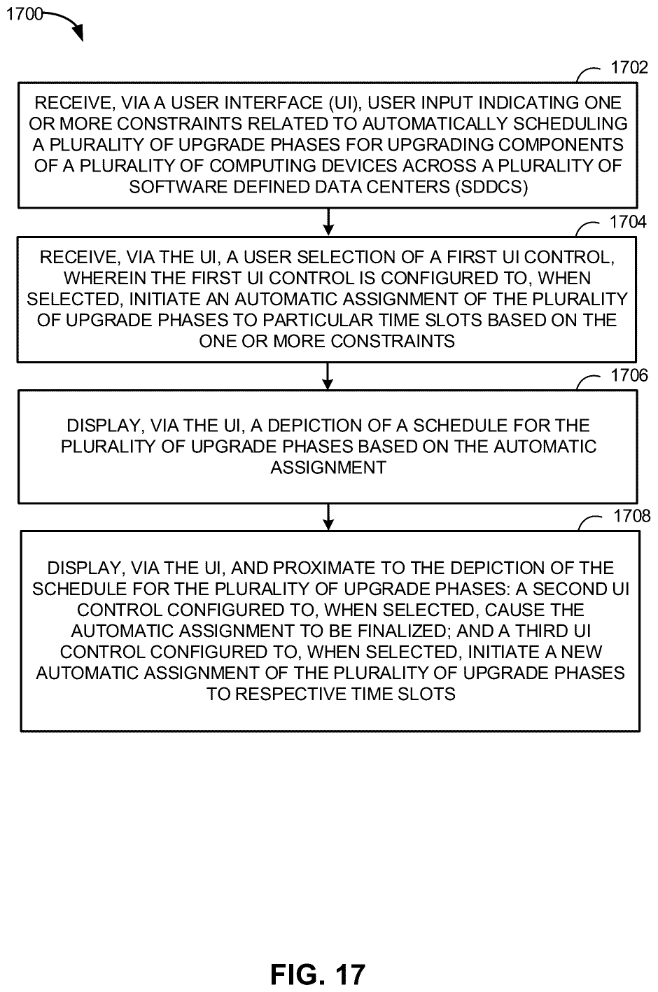

FIG. 17 depicts example operations 1700 related to automated resource-aware scheduling of software-defined data center (SDDC) upgrades. For example, operations 1700 may be performed by one or more components of upgrade manager 150 of FIG. 1.

Operations 1700 begin at step 1702, with receiving, via a user interface (UI), user input indicating one or more constraints related to automatically scheduling a plurality of upgrade phases for upgrading components of a plurality of computing devices across a plurality of SDDCs.

Operations 1700 continue at step 1704, with receiving, via the UI, a user selection of a first UI control, wherein the first UI control is configured to, when selected, initiate an automatic assignment of the plurality of upgrade phases to particular time slots based on the one or more constraints.

Operations 1700 continue at step 1706, with displaying, via the UI, a depiction of a schedule for the plurality of upgrade phases based on the automatic assignment.

Operations 1700 continue at step 1708, with displaying, via the UI, and proximate to the depiction of the schedule for the plurality of upgrade phases: a second UI control configured to, when selected, cause the automatic assignment to be finalized; and a third UI control configured to, when selected, initiate a new automatic assignment of the plurality of upgrade phases to respective time slots.

Some embodiments further comprise, after displaying the depiction of the schedule for the plurality of upgrade phases: receiving, via the UI, additional user input indicating one or more revised constraints; receiving a selection of the third UI control; and in response to the receiving the selection of the third UI control, initiating the new automatic assignment of the plurality of upgrade phases to the respective time slots based on the one or more revised constraints.

Some embodiments further comprise, after displaying the depiction of the schedule for the plurality of upgrade phases: receiving a selection of the second UI control; and in response to the receiving the selection of the second UI control, automatically scheduling the plurality of upgrade phases according to the automatic assignment.

Some embodiments further comprise: receiving, via the UI, input selecting a given SDDC of the plurality of SDDCs within the depiction of the schedule for the plurality of upgrade phases; receiving a selection of a fourth UI control that is configured to, when selected, initiate a re-scheduling of a selected SDDC for an alternative time slot; and in response to the receiving the selection of the fourth UI control and based on the input selecting the given SDDC, initiating a re-scheduling of the given SDDC.

In certain embodiments, the automatic assignment of the plurality of upgrade phases to the particular time slots is further based on physical computing resource utilization information for the plurality of computing devices.

Some embodiments further comprise predicting future physical computing resource utilization of the plurality of computing devices based on the physical computing resource utilization information, wherein the automatic assignment of the plurality of upgrade phases to the particular time slots is based on the predicted future physical computing resource utilization.

In certain embodiments, the one or more constraints indicated in the input comprise: a target start date; and a target duration.

Some embodiments further comprise determining upgrade capacities for the particular time slots based on support resource availability information, wherein the automatic assignment of the plurality of upgrade phases to the particular time slots is further based on the upgrade capacities.

Certain embodiments further comprise determining one or more scores for the automatic assignment of the plurality of upgrade phases to the particular time slots based on utilization of support resources associated with the particular time slots. Some embodiments further comprise displaying the one or more scores via the UI in association with the depiction of the schedule for the plurality of upgrade phases.

In some embodiments, the one or more scores comprise: an overutilization score indicating an extent to which the automatic assignment of the plurality of upgrade phases to the particular time slots overutilizes the support resources associated with the particular time slots; and an underutilization score indicating an extent to which the automatic assignment of the plurality of upgrade phases to the particular time slots underutilizes the support resources associated with the particular time slots.

Certain embodiments further comprise predicting durations of the plurality of upgrade phases based on historical upgrade duration data, wherein the automatic assignment of the plurality of upgrade phases to the particular time slots is based on the predicted durations of the plurality of upgrade phases.

Some embodiments further comprise displaying, via the UI, in association with the depiction of the schedule for the plurality of upgrade phases, a predicted total duration of the plurality of upgrade phases based on the predicted durations of the plurality of upgrade phases.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of automatically scheduling resource-aware software-defined data center (SDDC) upgrades, comprising:
receiving, via a user interface (UI), user input indicating one or more constraints related to automatically scheduling a plurality of upgrade phases for upgrading components of a plurality of computing devices across a plurality of SDDCs;
receiving, via the UI, a user selection of a first UI control, wherein the first UI control is configured to, when selected, initiate an automatic assignment of the plurality of upgrade phases to particular time slots based on the one or more constraints;
displaying, via the UI, a depiction of a schedule for the plurality of upgrade phases based on the automatic assignment; and
displaying, via the UI, and proximate to the depiction of the schedule for the plurality of upgrade phases:
a second UI control configured to, when selected, cause the automatic assignment to be finalized; and
a third UI control configured to, when selected, initiate a new automatic assignment of the plurality of upgrade phases to respective time slots.

2. The method of claim 1, further comprising:
after displaying the depiction of the schedule for the plurality of upgrade phases:
receiving, via the UI, additional user input indicating one or more revised constraints;
receiving a selection of the third UI control; and
in response to the receiving the selection of the third UI control, initiating the new automatic assignment of the plurality of upgrade phases to the respective time slots based on the one or more revised constraints.

3. The method of claim 1, further comprising:
after displaying the depiction of the schedule for the plurality of upgrade phases:
receiving a selection of the second UI control; and
in response to the receiving the selection of the second UI control, automatically scheduling the plurality of upgrade phases according to the automatic assignment.

4. The method of claim 1, further comprising:
receiving, via the UI, input selecting a given SDDC of the plurality of SDDCs within the depiction of the schedule for the plurality of upgrade phases;
receiving a selection of a fourth UI control that is configured to, when selected, initiate a re-scheduling of a selected SDDC for an alternative time slot; and
in response to the receiving the selection of the fourth UI control and based on the input selecting the given SDDC, initiating a re-scheduling of the given SDDC.

5. The method of claim 1, wherein the automatic assignment of the plurality of upgrade phases to the particular time slots is further based on physical computing resource utilization information for the plurality of computing devices

6. The method of claim 5, further comprising predicting future physical computing resource utilization of the plurality of computing devices based on the physical computing resource utilization information, wherein the automatic assignment of the plurality of upgrade phases to the particular time slots is based on the predicted future physical computing resource utilization.

7. The method of claim 1, wherein the one or more constraints indicated in the input comprise:
a target start date; and
a target duration.

8. The method of claim 1, further comprising determining upgrade capacities for the particular time slots based on support resource availability information, wherein the automatic assignment of the plurality of upgrade phases to the particular time slots is further based on the upgrade capacities.

9. The method of claim 1, further comprising determining one or more scores for the automatic assignment of the plurality of upgrade phases to the particular time slots based on utilization of support resources associated with the particular time slots.

10. The method of claim 9, further comprising displaying the one or more scores via the UI in association with the depiction of the schedule for the plurality of upgrade phases.

11. The method of claim 10, wherein the one or more scores comprise:
an overutilization score indicating an extent to which the automatic assignment of the plurality of upgrade phases to the particular time slots overutilizes the support resources associated with the particular time slots; and
an underutilization score indicating an extent to which the automatic assignment of the plurality of upgrade phases to the particular time slots underutilizes the support resources associated with the particular time slots.

12. The method of claim 1, further comprising predicting durations of the plurality of upgrade phases based on historical upgrade duration data, wherein the automatic assignment of the plurality of upgrade phases to the particular time slots is based on the predicted durations of the plurality of upgrade phases.

13. The method of claim 12, further comprising displaying, via the UI, in association with the depiction of the schedule for the plurality of upgrade phases, a predicted total duration of the plurality of upgrade phases based on the predicted durations of the plurality of upgrade phases.

14. A system for automatically scheduling resource-aware software-defined data center (SDDC) upgrades, comprising:
at least one memory; and
at least one processor coupled to the at least one memory, the at least one processor and the at least one memory configured to:
receive, via a user interface (UI), user input indicating one or more constraints related to automatically scheduling a plurality of upgrade phases for upgrading components of a plurality of computing devices across a plurality of SDDCs;
receive, via the UI, a user selection of a first UI control, wherein the first UI control is configured to, when selected, initiate an automatic assignment of the plurality of upgrade phases to particular time slots based on the one or more constraints;
display, via the UI, a depiction of a schedule for the plurality of upgrade phases based on the automatic assignment; and
display, via the UI, and proximate to the depiction of the schedule for the plurality of upgrade phases:
a second UI control configured to, when selected, cause the automatic assignment to be finalized; and
a third UI control configured to, when selected, initiate a new automatic assignment of the plurality of upgrade phases to respective time slots.

15. The system of claim 14, wherein the at least one processor and the at least one memory are further configured to:
after displaying the depiction of the schedule for the plurality of upgrade phases:
receive, via the UI, additional user input indicating one or more revised constraints;
receive a selection of the third UI control; and
in response to the receiving the selection of the third UI control, initiate the new automatic assignment of the plurality of upgrade phases to the respective time slots based on the one or more revised constraints.

16. The system of claim 14, wherein the at least one processor and the at least one memory are further configured to:
after displaying the depiction of the schedule for the plurality of upgrade phases:
receive a selection of the second UI control; and
in response to the receiving the selection of the second UI control, automatically schedule the plurality of upgrade phases according to the automatic assignment.

17. The system of claim 14, wherein the at least one processor and the at least one memory are further configured to:
receive, via the UI, input selecting a given SDDC of the plurality of SDDCs within the depiction of the schedule for the plurality of upgrade phases;
receive a selection of a fourth UI control that is configured to, when selected, initiate a re-scheduling of a selected SDDC for an alternative time slot; and
in response to the receiving the selection of the fourth UI control and based on the input select the given SDDC, initiating a re-scheduling of the given SDDC.

18. The system of claim 14, wherein the automatic assignment of the plurality of upgrade phases to the particular time slots is further based on physical computing resource utilization information for the plurality of computing devices

19. The system of claim 18, wherein the at least one processor and the at least one memory are further configured to predict future physical computing resource utilization of the plurality of computing devices based on the physical computing resource utilization information, wherein the automatic assignment of the plurality of upgrade phases to the particular time slots is based on the predicted future physical computing resource utilization.

20. A non-transitory computer readable medium storing instructions that, when executed by one or more processors, cause the one or more processors to:
receive, via a user interface (UI), user input indicating one or more constraints related to automatically scheduling a plurality of upgrade phases for upgrading components of a plurality of computing devices across a plurality of SDDCs;
receive, via the UI, a user selection of a first UI control, wherein the first UI control is configured to, when selected, initiate an automatic assignment of the plurality of upgrade phases to particular time slots based on the one or more constraints;
display, via the UI, a depiction of a schedule for the plurality of upgrade phases based on the automatic assignment; and
display, via the UI, and proximate to the depiction of the schedule for the plurality of upgrade phases:
a second UI control configured to, when selected, cause the automatic assignment to be finalized; and
a third UI control configured to, when selected, initiate a new automatic assignment of the plurality of upgrade phases to respective time slots.
